(19) United States
(12) Patent Application Publication
(10) Pub. No.: US 2007/0282459 A1
(43) Pub. Date: Dec. 6, 2007

(54) Method and Device for Monitoring Signal Processing Units for Sensors

(75) Inventors: Partrick Schafer, Eschborn (DE); Thomas Ohgke, Aalen (DE); Sebastian Patzold, Offenbach (DE); Otmar Simon, Pohlheim (DE); Tino Sonntag, Henau (DE)

Correspondence Address: CONTINENTAL TEVES, INC., ONE CONTINENTAL DRIVE, AUBURN HILLLS, MI, 48326-1581, US

(73) Assignee: Continental Teves AG & Co.oHG

(21) Appl. No.: 10/590,474

(22) PCT Filed: Feb. 18, 2005
(86) PCT No.: PCT/EP05/50724

§ 371 Date: May 11, 2007

(30) Foreign Application Priority Data
Feb. 23, 2004 (DE) 10 2004 009 029.7
Feb. 9, 2005 (DE) 10 2005 005 995.3

(51) Int. Cl. B60T 8/88; G05B 19/18

(52) U.S. Cl. 700/4

(57) ABSTRACT

The invention relates to a method and a device for monitoring signal processing units for sensors which detect the individual process control quantities or process measured values of a process. In order to improve the reliability of the sensor data of a vehicle, an at least redundant processing of the sensor data is carried out in two identical signal processing units (43, 31, 46; 44, 32, 45), which each have, independently and separately from the other, at least two processing devices (43, 44) in two evaluation devices (31, 32), whereby the sensor data are transmitted between the one processing device (43, 44) and the corresponding evaluation device (31, 32) through separate signal lines (60, 61).

### BACKGROUND OF THE INVENTION

The invention relates to a method and a device for monitoring signal processing units for sensors which detect the individual process control quantities or process measured values of a process.

Electronic stability programs are driving dynamics control systems for vehicles that serve to support the driver in critical driving situations during braking, accelerating and steering, and to intervene in cases where the driver himself has no possibility of intervening directly. The control system supports the driver during braking, particularly on a roadway with a low or changing friction value, on which the vehicle can no longer be controlled because of locking wheels, or could begin skidding upon accelerating, whereby there is a danger of the drive wheels spinning, as well as, finally, during steering on a curve during which the vehicle could oversteer or understeer. On the whole, not only the comfort, but also the active safety, is thereby significantly improved. The basis for such a control system is formed by a closed control circuit which, during the normal operation of the vehicle, assumes typical control tasks and, during extreme driving situations, is intended to catch the vehicle as quickly as possible. Sensors for the determination of the different driving dynamics parameters are, as the actual value transmitters, thereby particularly important. A plausible control presupposes that the sensors correctly reproduce the actual condition of the control system interval. This is particularly important during driving stability control actions in extreme driving situations, in which a deviation from control must be fully stabilized within a very short time. For this reason, the sensors in an electronic stability program (yaw rate sensor, lateral acceleration sensor, and steering angle sensor) must be monitored continuously. A corresponding online-sensor monitoring has the purpose of detecting errors in the sensors at an early stage, so that an error in control that could bring the vehicle into a safety-critical condition is ruled out.

The ESP systems that are in serial production at the present time use a multiple sensor (“sensor cluster”) for the determination of the rotational rate of the vehicle, as well as of the lateral and the longitudinal acceleration, if necessary. This sensor is placed in the passenger space and communicates with the ESP control device by way of a CAN interface (WO 99/47889).

Future applications (such as the ESP 2 or active front steering AFS, for example) even use the signals of the sensor cluster to influence the steering. Since steering interventions entail significantly higher risks than braking interventions, greater demands are also placed on the reliability of the sensing technology. Redundant systems, which can recognize error functions independently and react correspondingly, are required.

FIG. 1 depicts a known sensor cluster in a redundant design. The rotation rate sensor (11, 12) and the acceleration sensor (1, 2) are thus present twice. The signal processing is carried out in a commonly used set of chips. The A/D transformers (ADC 1 and ADC 2) and the processor core (μC1, μC2) are thereby designed redundantly, while the signal paths (13, 14) (such as the SPI interface between the transformers and processors, reception register, etc., for example) are only present once, however. Defective sensor elements, as well as errors in the program design, can thus be detected.

It is disadvantageous, however, that errors are not detected on the transmission path between the A/D transformer (ADC) and the processor, just as errors in the A/D transformer itself (such as partial bits, for example), which lie within the order of magnitude of the permissible signaling precision, are also not detected.

The task that forms the basis for the invention is thus that of creating a method and a device for monitoring the signal processing of sensors of the type stated above that has the reliability that is necessary, particularly for driving stability control and/or comfort control during active steering interventions for vehicles.

### SUMMARY OF THE INVENTION

This task is solved by means of a method of the type stated above, which is characterized by an at least redundant processing of the sensor data in two identical signal processing units, which are each evaluated and checked for plausibility, independently and separately from one another, by means of at least two processing devices in two evaluation devices, whereby the sensor data are transmitted between the one processing device and the one evaluation device through separate signal lines.

It is advantageous that, in every evaluation device sensor, the data that are separately evaluated and checked for plausibility are exchanged by way of an interface between the evaluation devices. The sensor data and the condition information of the specific other evaluation unit that have been evaluated and checked for plausibility are thereby sent to a superordinate control device of the vehicle by each evaluation device, independently of the other one.

The transmission of the sensor data and the condition information that have been evaluated and checked for plausibility to the other evaluation unit is carried out, by way of internally separate signal lines, to one data bus and the control device of the vehicle.

This task is additionally solved with a device of the type stated above, which is characterized by at least two identical signal processing units for the redundant processing of the sensor data, with at least two processing devices and two evaluation devices, in which the sensor data are evaluated and checked for plausibility independently of and separately from one another, whereby one processing device is connected with the one evaluation device by way of separate signal lines, and the sensor data are transmitted between the one processing device and the one evaluation device by way of the separate signal line.

The following advantages result from the invention:
Completely redundant signal path all the way to the signal output. All errors appearing in the system can be detected.
Prevention of a loss of comfort from a premature system activation caused by errors that are still within the framework of the range specified.
Suitability for highly sensitive systems with very low control thresholds.
Cost savings through the use of components identical to the non-redundant standard sensor cluster. No special components (such as double core processors, for example) are necessary.

Examples of implementation of the invention are depicted in the diagrams, and are described in further detail in the following.

### BRIEF DESCRIPTION OF THE DRAWINGS

These depict the following:

FIG. 1: A simple redundant sensor cluster in accordance with the state of the art;

FIG. 2: A schematic representation of the structure of an ESP system;

FIG. 3: A completely redundant sensor cluster in accordance with the invention.

### DETAILED DESCRIPTION OF THE DRAWINGS

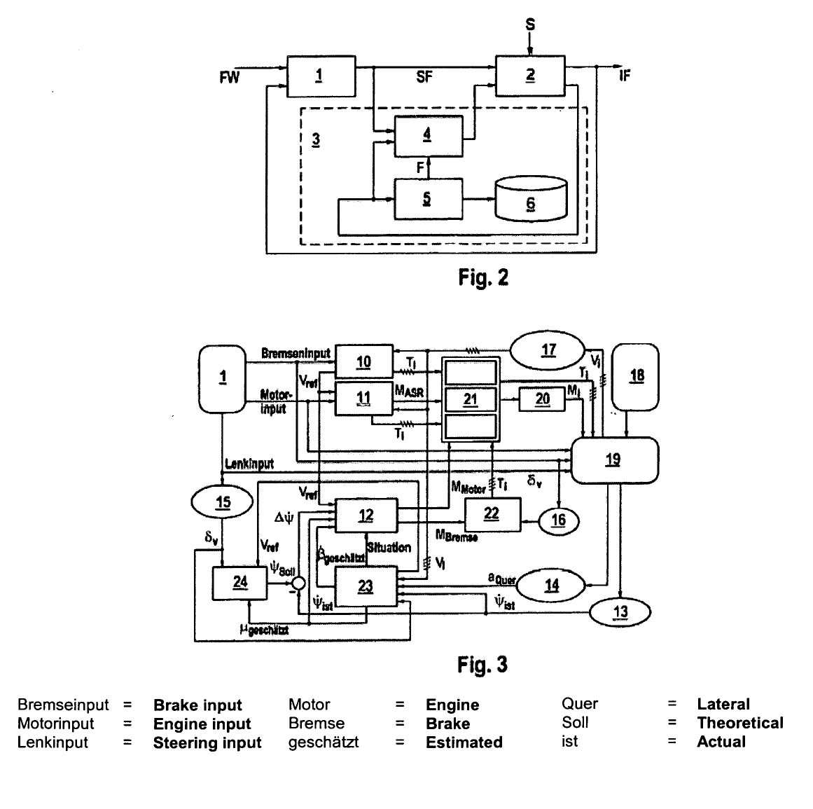

The process of auto driving can be considered, in accordance with FIG. 2, in a technical control sense, as a control circuit in which a driver (1) represents the control unit, and a vehicle (2) represents the control system. The control inputs are thereby the personal driving wish (FW) of the driver, which he determines through the continuous observation of the road traffic. The actual values (IF) are the current values for the direction and speed of travel, which the driver determines by means of his sight or driving sensations, as the case may be. The control variables (SF) are, finally, the steering wheel angle, the position of the transmission, as well as the positions of the gas and brake pedals, which are determined by the driver on the basis of the deviations between the theoretical and the actual values.

Such a type of control is frequently made more difficult by disturbances (S), such as changes in friction values, irregularities in the roadway, lateral wind, or other influences, since the driver cannot precisely detect these, but still must take them into consideration during the control, however. For this reason, the driver (1) can, to be sure, generally manage the tasks conveyed to him—that is to say, controlling and observing the process of driving the auto under normal driving conditions—on the basis of his training and accumulated experience without difficulties. Under extreme situations and/or under the extraordinary driving conditions noted, under which the physical friction boundaries between the roadway and the tires are exceeded, the danger does exist, however, that the driver will react too late, or incorrectly, and will lose control of his vehicle.

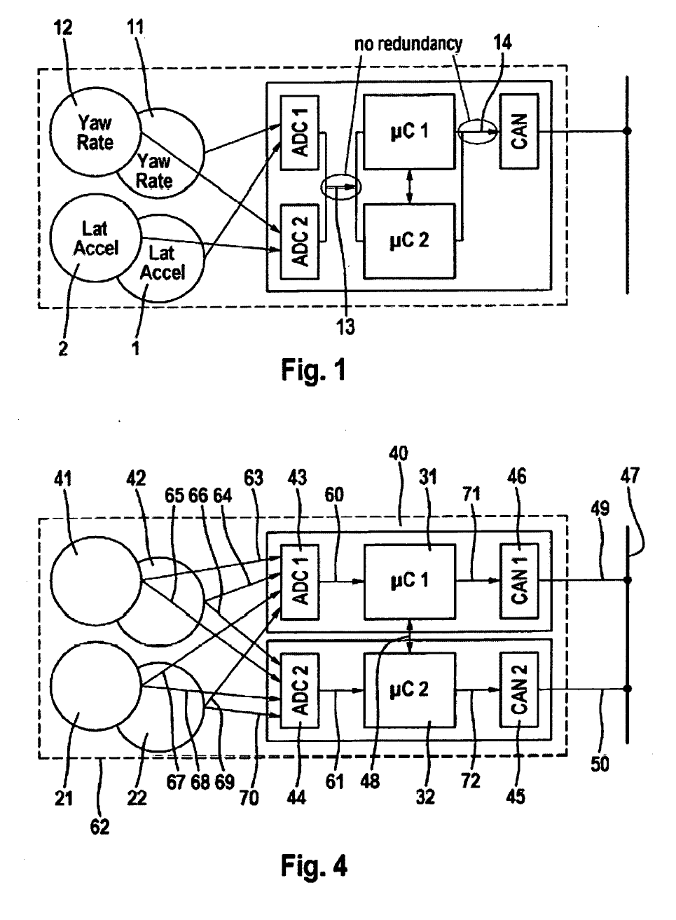

In order to be able to take even these driving situations into account, the driving dynamics control system is supplemented by a subordinate control circuit (ESP) which, in accordance with FIG. 1, comprises a control algorithm (4), a system monitoring unit (5), and an error memory (6). Measured driving condition values are thereby transmitted to the system monitoring unit (5) and to the control algorithm (4). The system monitoring unit (5) produces an error message (F), if necessary, which is transmitted to the error memory (6) and to the control algorithm (4). The control algorithm (4) then acts on the vehicle (2) in dependence on the control variables produced by the driver (1). Typical control tasks are carried out with this control circuit. Under extreme driving situations, the vehicle can be caught again as quickly as possible.

FIG. 3 depicts the structure of such a control circuit, which essentially comprises an anti-blocking system (10), a drive skidding control (11), and a yaw momentum control (12). The system can be supplemented by a steering angle control not depicted in further detail, such as is described in WO 2004/005093, for example. In addition, yaw rate sensors (13), lateral acceleration sensors (14), a steering angle sensor (15), a pressure sensor (16), and four wheel speed sensors (17) are provided, which are used both as actual value transmitters for the determination of the control deviation, as well as for the formation of a yaw rate theoretical value and various intermediate values.

The process control inputs produced by the driver (1) through the activation of the gas and brake pedal, as well as the steering wheel, are added to the drive skidding control (11), the anti-blocking system (10), and the pressure sensor (16), as well as the steering angle sensor (15), as the case may be. Vehicle-specific non-linearities, fluctuations of the friction values, lateral wind influences, etc., are summarized as disturbances or unknown values (18) and influence the longitudinal and lateral dynamics of the vehicle (19). This dynamic (19) is, furthermore, influenced by the control inputs noted, as well as by the output signals of an engine management unit (20), and acts on the wheel speed sensors (17), the yaw rate sensors (13), the lateral acceleration sensors (14), as well as the pressure sensor (16). A control arbitration unit (21), to which the output signals of the anti-blocking system (10), the drive skidding control (11), the yaw momentum control (12), the steering angle control, and a braking intervention algorithm (22) are transmitted, serves for the distribution of priorities to these signals in relation to their effect on the engine management unit (20), or directly on the driving dynamics (19). The braking intervention algorithm (22) is thereby influenced by the yaw momentum control (12) and the pressure sensor (16). Finally, a driving condition detection unit (23) is provided, to which the signals of the steering angle sensor (15), the yaw rate sensors (13), the lateral acceleration sensors (14), as well as the wheel speed sensors (17) are transmitted, and the output signals of which influence the yaw momentum control (12) as well as a single-track reference model (24), by means of which a theoretical yaw rate desired or the steering angle is produced.

The sensor cluster (40), with a completely symmetrical redundancy of the signal processing units (43, 31, 46 and 44, 32, 45), is depicted in FIG. 4. The sensor cluster (40) consists of two identical separate paths for the signal processing. The rotation rate sensor (41, 42) and the acceleration sensor (21, 22) are present twice. The sensors (41, 42, 21, 22) and the signal processing units (43, 31, 46 and 44, 32, 45) are preferably positioned in a common casing (62). Two signal processing devices (43, 44), such as an analogue-digital signal transformer, which convert the analogue output signal of the sensors into a digital input signal, are assigned to them. Two evaluation devices (31, 32), such as identical microcontrollers, digital signal processors (DSP), or programmable logic modules, particularly ASIC's, are used for the signal processing. The sensor data are transmitted between the one processing device (43, 44) and the one evaluation device (31, 32) by way of a separate signal line (60, 61). The signals, which are now present in digital form, are processed in the evaluation devices (31, 32) in digital form. The evaluation-related sensor signals are applied to the output side of the evaluation devices (31, 32). These are supplied to the serial vehicle communication bus (47) by way of the two CAN controllers (45, 46) provided in the evaluating devices (31, 32). The evaluation devices (31, 32), which are connected with the integrated CAN (controller area network) by way of the separate lines (71, 72), thereby assume the following system functions:
Preparation of a driver signal/driver voltage for the activation of the electrical-mechanical transformer of the rotation rate sensor (41, 42).
Reception of the signals of the rotation rate sensor (41, 42) with specific algorithmic allocations and filtering in order to obtain a numerical value for the yaw movement of a vehicle.
Conversion of the numerical values of the yaw movement of a vehicle into the CAN and transfer to the serial bus (47).

These evaluation devices (31, 32) can correspond precisely to the components used in the known sensor cluster (such as EP 1 064 520 B1, for example)—that is to say, no special components are then needed for this system.

The outputs of both of the signal processing units (43, 31, 46; 44, 32, 45) can be joined in the sensor cluster (40), or else they can be connected, in separate lines (49, 50), with the vehicle communication bus (here: CAN). In the event of a joining in the sensor cluster, the interface remains compatible with the existing system.

Each of the evaluation devices (31, 32) has access to all of the sensor data, and carries out a signal processing and plausibility evaluation independently of the others. It reports the result of its plausibility evaluation and of its computations, if applicable, to its partner by way of an appropriate interface (48).

Each of the evaluation devices (31, 32) thereupon sends a communication (here: CAN message) to the (ESP) control device independently of the others. This communication contains, in coded form, the specific data, the status of its own plausibility evaluation, as well as the condition signaled by the partner.

The control device decides, in dependence on the status flags contained in the communications, whether the data are to be evaluated as valid, as conditionally valid, or as incorrect. Conditionally valid data can be evaluated through comparison with other values, such as with the wheel speeds, for example, by means of the model:

$${\dot{ψ}}_{m} = \frac{{v}_{vr} - {v}_{vl}}{S}$$

—and are additionally used, if necessary. (S) is hereby the lane width of the vehicle, (Vᵥᵣ) is the wheel speed, front right, and (vᵥₗ) is the wheel speed, front left. Thus, in the event of a failure of a yaw rate signal, such as during an ESP control of the control device, for example, the intact signal can be identified and used to continue the control by means of the available model data.

In terms of expense, this solution corresponds to two separate identical sensor clusters. It has the advantage, however, that each cluster can have access to the sensing technology of the other one. Additional information is made available by this means.

The redundancy concept illustrated here in the example of a sensor cluster can be applied to any other sensor systems desired. Thus, the following variations, which are jointly included in the invention, are conceivable:
The use of n≧2 signal processing units (43, 31, 46), which access the signals of any desired number of sensors (41, 42, 21, 22), a portion of which may be redundantly present, but which do not have to be, however.
Redundant sensors (41, 42) may be present in double form or in multiple form (>2). With three or more sensors, a decision can be made as to which sensor is defective, even during the signal processing.
The sensors (41, 42, 21, 22) and the signal processing units (43, 31, 46; 44, 32, 45) do not have to be located in the same casing (62).
The connection (63-70) of the sensors to the signal processing units may be carried out by analogue or digital means.
The connection of the signal processing units (43, 31, 46; 44, 32, 45) to the superordinate control device may be carried out by analogue or digital means.
The signal processing units (43, 31, 46; 44, 32, 45) exchange status information, computation results, or even no information at all.
The signal processing units (43, 31, 46; 44, 32, 45) can carry out different tasks at different times (such as during the initialization phase or during self-diagnosis, for example).
Not every signal processing unit (43, 31, 46; 44, 32, 45) has to evaluate all sensor signals, but even partially redundant systems are possible.

In the event that a superordinate system is not acceptable, there is the advantageous form of implementation of only allowing one signal processing unit (43, 31, 46; 44, 32, 45) to communicate actively. The other one(s) initially remain(s) passively in the background, but nevertheless carry out the checking for plausibility with the corresponding internal communication, however. It is only if a discrepancy has been determined there that the passive signal processing units carry out a veto and actively report to the superordinate system. If realized in practical terms, this could appear as follows:
The signal processing units (43, 31, 46) and (44, 32, 45) are identical, but have a software coded by means of a PIN number, however, which makes two types of operation possible.
The signal processing unit (43, 31, 46) works as a master (coding 1) and sends the result of its evaluation to the CAN.
[The] signal processing unit (44, 32, 45) works as a slave (coding 0) and compares the result of the master received through the CAN with its own computations. It reports an agreement or a deviation, as the case may be, to the master, and sends a CAN message to the system with an error flag set, if necessary.
The communication can take place by way of two lines, MATCH, MATCH_N, for example, which toggle in an opposite manner in every software loop and, in the event of errors, either both go to 1 or both go to 0.
The signal processing unit (43, 31, 46) recognizes, through the acknowledgement noted above, that the signal processing unit (44, 32, 45) is available and is working.
The signal processing unit (44, 32, 45) recognizes, through the receipt of the CAN messages, that the signal processing unit (43, 31, 46) is available and is working.

1-8. (canceled)

9. A method for monitoring signal processing units for sensors, the method comprising:
detecting at least one individual process control quantitie or process measured values;
evaluating redundant processing of sensor data in two identical signal processing units (43, 31, 46 and 44, 32, 45);
checking for plausibility, independently and separately from one another, by at least two processing devices (43, 44) in two evaluation devices (31, 32); and
transmitting the sensor data between one processing device (43, 44) and one evaluation device (31, 32) through separate signal lines (60, 61).

10. A method according to claim 9, wherein the sensor data that is separately evaluated and checked for plausibility in every evaluation device (31, 32) is exchanged by way of an interface between the evaluation devices (31, 32).

11. A method according to claim 9, wherein sensor data and the condition information of a specific other evaluation unit that have been evaluated and checked for plausibility are sent to a control device of a vehicle by each evaluation device (31, 32), independently of the other one.

12. A method according to claim 11, wherein the sensor data and condition information of the other evaluation unit (31, 32), which have been evaluated and checked for plausibility, are transmitted to the control device of the vehicle by way of internal separate signal lines (49, 50) by way of one data bus each (47).

13. A device for monitoring signal processing units for sensors, which determine the individual process control quantities or process measured values of a process, the device comprising:
two or more identical signal processing units (43, 31, 46; 44, 32, 45) for redundant processing of data; and
two or more processing devices (43, 44) and two evaluation devices (31, 32), in which sensor data is evaluated and checked for plausibility independently of and separately from one another, wherein each processing device (43, 44) is connected with a specific evaluation device (31, 32) by way of separate signal lines (60, 62), and the sensor data is transmitted between the one processing device (43, 44) and the specific evaluation device (31, 32) by way of the separate signal line (60, 61).

14. A device according to claim 13, wherein the sensor data, which is separately evaluated and checked for plausibility in every evaluation device (31, 32), is exchanged by way of an interface between the evaluation devices (31, 32).

15. A device according to claim 13, wherein each evaluation device (31, 32), independently of the others, sends the sensor data and the condition information of the other evaluation unit, which are evaluated and checked for plausibility, to a vehicle control device.

16. A device according to claim 13, wherein each evaluation unit (31, 32) is connected with a data bus (45, 46) by way of an internal separate signal line (71, 72), and the sensor data and condition information of the specific other evaluation unit (31, 32) that have been evaluated and checked for plausibility are transmitted to the vehicle control device by way of the specific data bus (45, 46).
